(19) United States
(12) Patent Application Publication
(10) Pub. No.: US 2014/0062680 A1
(43) Pub. Date: Mar. 6, 2014

(54) SMART ADAPTER AND REMOTE CONTROL SYSTEM USING THE SAME

(71) Applicants: HON HAI PRECISION INDUSTRY CO., LTD., New Taipei (TW); HONG FU JIN PRECISION INDUSTRY (ShenZhen) CO., LTD, ShenZhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN)

(73) Assignees: HON HAI PRECISION INDUSTRY CO., LTD., New Taipei (TW); HONG FU JIN PRECISION INDUSTRY (ShenZhen) CO., LTD, ShenZhen (CN)

(21) Appl. No.: 13/951,479

(22) Filed: Jul. 26, 2013

(30) Foreign Application Priority Data
Aug. 31, 2012 (CN) 2012103179921

(51) Int. Cl. G08C 19/28

(52) U.S. Cl. CPC G08C 19/28
USPC 340/12.32

(57) ABSTRACT

A remote control system includes a remote control device in the hands of a user, a number of home devices and a smart adapter. The home devices and the smart adapter are connected to a power source via power lines. The remote control device sends remote control information to the smart adapter directly or via a server. The smart adapter includes a modulation module, which is configured to modulate the remote control information with a UID of the target home device and convert network protocols, then generate an effective control signal. The smart adapter transmits the control signal to the target home device via the power lines.

### BACKGROUND

1. Technical Field

The present disclosure relates to remote control technology, and particularly to a smart adapter capable of functioning by remote control and a remote control system using the smart adapter.

2. Description of Related Art

Adapter is usually connected between a commercial power source and an electronic device. The adapter obtains electrical power from the power source, and converts the power to a proper and stable direct current (DC) power supply, to power the electronic device. However, that function of the adapter is the sole function, and user needs to manually connect or disconnect the adapter with the electronic device or the power source, to control the electrical connection between the electronic device and the power source, which is inconvenient for user.

Therefore, there is room for improvement within the art.

### BRIEF DESCRIPTION OF THE DRAWINGS

Many aspects of the embodiments can be better understood with reference to the following drawing. The components in the drawing are not necessarily drawn to scale, the emphasis instead being placed upon clearly illustrating the principles of the present disclosure.

The FIGURE is a block diagram of a remote control system, according to an embodiment.

### DETAILED DESCRIPTION

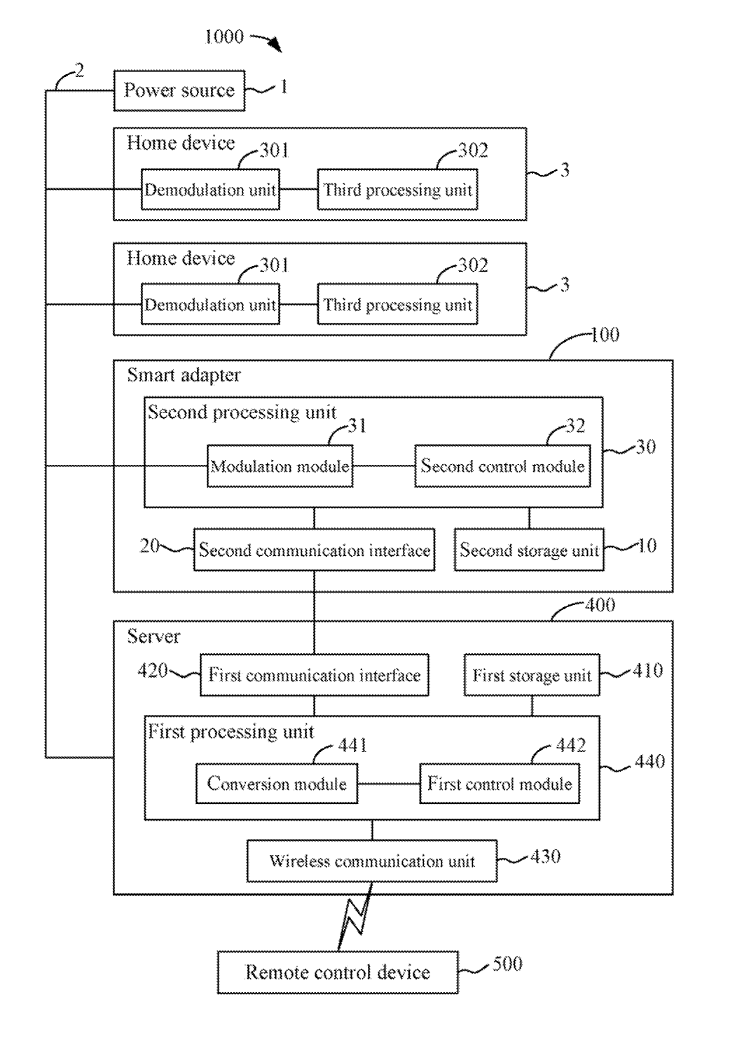

Referring to FIG. 1, a remote control system 1000 is provided. The system 1000 includes a number of home devices 3, a smart adapter 100, a server 400 and a remote control device 500. In this embodiment, each of the home devices 3, the smart adapter 100 and the server 400 are connected to a commercial power source 1 via power lines 2. The smart adapter 100 communicates with each home device 3 via PLC (Power Line Communication) technology or OPLC (Optical Fiber Power Line Communication) technology. The server 400 is connected to the smart adapter 100, and the remote control device 500 communicates with the server 400 via wireless communication technology.

In this embodiment, each home device 3 is a smart device, and can execute functions in response to control signals. The home devices 3 may include, but are not limited to, a fridge, an air conditioner, a fan, a computer, a TV, an audio player, an electric rice cooker, a microwave oven, a water heater, and a lamp. Both of the server 400 and the remote control device 500 may be selected from a group consisting of a mobile phone, a tablet computer, and a notebook computer.

In use, the remote control device 500 communicates with the server 400 and sends remote control information for control of a target home device 3 to the server 400. The server 400 receives the remote control information from the remote control device 500, and transmits the remote control information to the target home device 3 via the smart adapter 100, to control the target home devices 3 to execute functions corresponding to the remote control information. Such that, user can remote control each individual home device 3 anywhere and anytime via the remote control device 500.

Specifically, in this embodiment, each device in the system 1000 is provided with a unique identification code (UID) so that it can be uniquely identified by other devices.

The remote control device 500 can be operated by user to generate and send the remote control information to the server 400. The remote control information can be a short message or voice information, and may be to turn on or turn off a target home device, or to adjust a luminance or a temperature controlled by the target home device. In this embodiment, the remote control information contains a name of a target home device.

The server 400 includes a first storage unit 410, a first communication interface 420, a wireless communication unit 430 and a first processing unit 440. The first storage unit 410 stores the UID codes and the names of the home devices 3. The wireless communication unit 430 wirelessly communicates with the remote control device 500, and receives the remote control information from the remote control device 500.

The first processing unit 440 is connected to the first storage unit 410, the first communication interface 420 and the wireless communication unit 430. The first processing unit 440 includes a conversion module 441 and a first control module 442. In this embodiment, the conversion module 441 reads the UID code of the target home device from the first storage unit 410 in response to the remote control information, and converts the received remote control information and the UID code into a control command. Such that, the control command contains the UID code of the target home device. The first communication interface 420 is connected to the smart adapter 100, and the first control module 442 controls the first communication interface 420 to transmit the control command to the smart adapter 100. In this embodiment, the first communication interface 420 is a USB port.

The smart adapter 100 includes a second storage unit 10, a second communication interface 20 and a second processing unit 30. The second storage unit 10 stores the UID codes of the home devices 3. The second communication interface 20 is connected to the first communication interface 420 of the server 400, and receives the control commands from the server 400. In this embodiment, the second communication interface 20 is a USB plug.

The second processing unit 30 is connected to the second storage unit 10 and the second communication interface 20, and includes a modulation module 31 and a second control module 32. In this embodiment, the modulation module 31 modulates each received control command and converts network protocols, to generate an effective control signal. The modulation module 31 is connected to the power source 1 via the power lines 2, and the second control module 32 controls the modulation module 31 to transmit the control signals to the target home device via the power lines 2. In this embodiment, each control signal is a PLC signal or an OPLC signal which can be transmitted in the power lines 2.

In another embodiment, the smart adapter 100 also includes the wireless communication unit 430. The second storage unit 10 stores the UID codes and the names of the home devices 3. The modulation module 31 reads the UID code of the target home device from the second storage unit 10 in response to the remote control information, and modulates the remote control information with the UID code of the target home device and converts network protocols, to generate an effective control signal. Therefore, the smart adapter 100 can communicate with the remote control device 500 and receive remote control information directly from the remote control device 500, and the server 400 is thus not needed.

In this embodiment, each home device 3 includes a demodulation unit 301 and a third processing unit 302. The demodulation unit 301 is connected to the power source 1 via the power lines 2. The demodulation unit 301 is configured to receive incoming control signals transmitted from the smart adapter 100 via the power lines 2, and demodulates the control signals and converts network protocols as required. In this embodiment, although all the home devices 3 can receive the control signals, only the home device 3 having the UID code matching the UID code in the control signals can demodulate the control signals and convert network protocols as required. The third processing unit 302 executes functions in response to the control signals.

Therefore, the smart adapter 100 and remote control system 1000 allow a user to operate the remote control device 500 to remotely control any target home device which is connected to the power lines, via the smart adapter 100 and the power lines 2.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A smart adapter comprising:
a communication interface configured to receive a control command for control of a target home device from a server, wherein the control command contains a UID code of a target home device which is connected to a power source via power lines; and
a modulation module for electrical connection to the power source via the power lines, and the modulation module configured to modulate the received control command and convert network protocols, to generate an effective control signal, and transmit the control signal to the target home device via the power lines.

2. The smart adapter as described in claim 1, wherein the smart adapter communicates with the target home device via PLC technology or OPLC technology.

3. A remote control system comprising:
a server comprising a first communication interface;
a plurality of home devices connected to a power source via power lines;
a smart adapter comprising:
a second communication interface connected to the first communication interface of the server, and configured to receive a control command for control of a target home device from the server, wherein the control command contains a UID code of a target home device; and
a modulation module for electrical connection to the power source via the power lines, and the modulation module configured to modulate the received control command and convert network protocols, to generate an effective control signal, and transmit the control signal to the target home device via the power lines.

4. The system as described in claim 3, wherein the smart adapter communicates with each of the home devices via PLC technology or OPLC technology.

5. The system as described in claim 3, further comprising a remote control device, the remote control device configured to generate and send remote control information for control of the target home device to the server in response to user's operation, wherein the remote control information is selected from a group consisting of a short message, and voice information.

6. The system as described in claim 5, wherein the server comprises:
a first storage unit storing the UID codes of the home devices;
a wireless communication unit wirelessly communicating with the remote control device, and receiving the remote control information from the remote control device; and
a conversion module configured to read the UID code of the target home device from the first storage unit in response to the remote control information, and convert the received remote control information and the UID code into the control command

7. The system as described in claim 3, wherein the first communication interface is a USB port, and the second communication interface is a USB plug.

8. The system as described in claim 3, wherein each home device comprises a demodulation unit connected to the power source via the power lines, the demodulation unit configured to receive incoming control signal transmitted from the smart adapter via the power lines, and demodulate the control signals and convert network protocols, if the UID code of the home device matches the UID code in the control signal.

9. A smart adapter comprising:
a storage unit storing UID codes of a plurality of home devices which are connected to a power source via power lines;
a wireless communication unit wirelessly communicating with a remote control device, and receiving remote control information for control of a target home device from the remote control device; and
a modulation module for electrical connection to the power source via the power lines, and the modulation module configured to read the UID code of the target home device from the storage unit in response to the remote control information, and modulate the remote control information with the UID code of the target home device and convert network protocols, to generate an effective control signal, and transmit the control signal to the target home device via the power lines.

10. The smart adapter as described in claim 9, wherein the smart adapter communicates with the target home device via PLC technology or OPLC technology.
